(19) United States
(12) Patent Application Publication
(10) Pub. No.: US 2026/0020584 A1
(43) Pub. Date: Jan. 22, 2026

(54) DRYING PLANT FOR THE PRODUCTION OF CONFECTIONERY PRODUCTS

(71) Applicant: PINCO SA, Stabio (CH)

(72) Inventor: CESARE CATELLI, Uggiate Trevano (IT)

(21) Appl. No.: 18/993,497

(22) PCT Filed: Jul. 6, 2023
(86) PCT No.: PCT/IB2023/056989

§ 371 Date: Jan. 10, 2025

(30) Foreign Application Priority Data
Jul. 13, 2022 (CH) CH000834/2022
Jul. 13, 2022 (IT) 102022000014719

(51) Int. Cl. A23G 7/02

(52) U.S. Cl. CPC A23G 7/02

(57) ABSTRACT

A drying plant (100) for the production of confectionery products is described, comprising a drying chamber (3), an air treatment unit (2), a delivery assembly (4) and a suction assembly (5), an inner air distribution assembly fluidically connected to said delivery assembly (4) and to said suction assembly (5) so as to form a closed air circuit characterized in that said inner distribution assembly comprises at least one closed-section delivery channel (7) comprising a plurality of primary outlets (8) configured to send a portion of the airflow into the lower portion of the drying chamber (8).

### FIELD OF THE INVENTION

The present invention relates to the field of the plants for the production by drying of confectionery products. More specifically, the invention concerns a drying plant for the production of confectionery products.

### KNOWN ART

As is well known, the production of confectionery products, such as gummy candies commonly known as “Jelly”, on an industrial scale is implemented through a process that features a casting step of the product, still in a semi-liquid or viscous state, into a receiving element that is able to ensure that the product can release some of the moisture contained at the initial stage but maintain the established shape and size, and a subsequent drying step of the products in a specific dryer.

Starch, silicone or plastic molds are generally used for this.

The preparation of the mixture is done considering that confectionery can have a solid structure with softness and brilliantness imparted by a base of gelatin, starch and gelatin or starch only. Each specific recipe may include additives, sugars, water and other components such as starches and different spice berries.

Commonly in the production of gummy candies, a powder component, such as starch, is used for molding products. The shaping of the product is generated in it and the product remains contained inside it throughout the drying process.

Production is carried out by molding the desired shapes inside starch-filled cassettes, where the shapes imprinted in the powder element are negative to those of the product. Subsequently, the product in semi-liquid or viscous form, which must undergo the drying process due to the high moisture content present at the end of mixing all the elements that make up the given recipe of each individual product, is casted in these.

After casting, the product is ready for drying, where drying normally takes place inside specific tunnels or chambers through forced air convection.

The purpose of drying is to generate a solid matrix which must match the desired product specifications, which in the case of jelly-based products is achieved through the gelling process, which takes place simultaneously with drying.

By filling the cassettes with a powder element an easy removal of the dried confectionery is also ensured, while also preventing it from being ruined due to contact with solid surfaces, on which the product would tend to stick.

Furthermore, the distribution process of the trays, if it is automated, can ensure easy replacement of formed confectionery with new ones to be processed, thus restarting the process.

The drying conditions under which confectionery is produced are product-specific, may take different times due to the gelling process and the significant decrease in temperature and moisture inside the products.

The drying conditions used also depend on the size of the confectionery product, its composition and the type of product to be obtained.

Typically, the trays filled with powder and a confectionery mass deposited inside are placed in a conditioning chamber for a period of about 12-72 hours. In this conditioning or drying chamber, the airflow, used as a means of heat and mass exchange with the products, is maintained at a temperature and humidity suitable for giving the product the desired shapes and characteristics.

The temperature and humidity conditions used also serve to ensure that the gelling process takes place. This process generates the compactness of the product. However, a gummy candy that has undergone only the latter process but has not been sufficiently dried is generally regarded as unsuitable for further processing.

The shelf life of confectionery is given by its own level of water-activity generated during the drying process. Drying also generates the appropriate degree of toughness to the product that will also allow to prevent it from breaking or being damaged in the handling steps of the same.

The drying process takes place inside specific chambers or tunnels, in which mainly moisture is exported from the confectionery from the powder product containing it but also from the air forced inside the chamber, whose temperature and humidity are controlled.

At the end of the process inside these chambers, the gummy candies and the powdered product acting as a container are separated. The moisture content inside the casting powder, starch, during the process increases to levels that make it unsuitable for immediate reuse. By “unsuitable” is meant an element whose functionality, as a forming agent and as a dehydration potential for confectionery, is lost or decreased to a level that is no longer acceptable.

The Applicant thus noted that in the current drying plants, air parameters such as temperature and humidity are controlled, but airflow in terms of flow path is not controlled.

The Applicant was faced with the problem of making a drying plant that would overcome the problems of existing drying plants, in particular in the controllability of the airflow entering the chamber, in particular in terms of flow rate, speed and directionality of the flow inside the drying chamber.

### SUMMARY OF THE INVENTION

Therefore, in its first aspect, the invention concerns a drying plant for the production of confectionery products, comprising a drying chamber, having a longitudinal extent along a longitudinal axis and a transverse axis arranged substantially orthogonally to said longitudinal axis, an air treatment unit, a delivery assembly and a suction assembly, an inner air distribution assembly fluidically connected to said delivery assembly and said suction assembly so as to form a closed air circuit characterized in that said inner distribution assembly comprises at least one closed-section distribution channel, comprising a plurality of primary outlets configured to feed air into the upper portion of the drying chamber and to send at least one portion of the fed airflow into the lower portion of the drying chamber;
said distribution channel extending in the upper portion of the drying chamber for at least 70% of the longitudinal extent of said drying chamber;
said suction assembly comprising air suction openings arranged in the upper portion of said drying chamber;
said air suction openings being away, in the transverse axis direction, from said distribution channel so that the inlet airflow from said distribution channel, once fed into the upper portion of the drying chamber and sent predominantly in the lower portion of the drying chamber, crosses said drying chamber in transverse direction and exits through the suction openings. The Applicant found that feeding the airflow into the drying chamber and suctioning the airflow from above of the drying chamber but at diametrically opposite positions along the longitudinal direction of the chamber allows maximum freedom of movement for loading/unloading the drying chamber by means of forklifts (in most cases self-driven).

The design of the air delivery system generates high-speed jets directed downward (floor). This is to avoid blowing directly on the starch contained in the trays placed inside the drying chamber, thus avoiding spreading it into the chamber itself but more importantly avoiding potentially dangerous (explosive) conditions.

Feeding the stacks of trays exposed to these jets occurs indirectly, due to the natural and progressive expansion of the air jets along the descent to the floor. Thus, at an average level, the airflow follows what is the pressure gradient generated in the drying chamber, having maximum peak on the delivery side at the floor and minimum on the suction side but at the height of the drying chamber roof.

By upper portion of the suction chamber is meant a portion that is placed more than 60% of the height above the floor of the drying chamber.

The present invention, in the aforementioned aspect, can have at least one of the preferred characteristics hereinafter described.

Preferably, each primary outlet has a plan area between 2000 mm² and 6000 mm². Conveniently, the primary outlets are evenly spaced on the distribution channel. Advantageously, each primary outlet comprises at least one first deflector fin extending substantially vertically from the distribution channel and configured to assist in directing the airflow towards the lower portion of said drying chamber; each first deflector fin being arranged around a primary outlet so as to wrap it at least partially.

Preferably, each first deflector fin is arranged around the primary outlet so as to not to fully wrap it.

Conveniently, the distribution channel comprises a plurality of secondary outlets having a plan area which is less than that of the primary outlets; the secondary outlets being evenly spaced along said distribution channel.

Preferably, each secondary outlet has a plan area between 1500 and 5000 mm². Advantageously, each secondary outlet comprises at least one second flow deflector fin.

Preferably, each second deflector fin is arranged along an axis adapted to form an acute angle a with the vertical between 50 and 90 degrees, including extremes.

Conveniently, each second deflector fin is arranged around a secondary outlet so as to fully wrap it.

Advantageously, the distribution channel has a trapezoidal shape section which converges at the bottom.

Preferably, the distribution channel is placed at a first lateral wall of said drying chamber; the suction openings of the suction assembly are arranged in the proximity of a second lateral wall of the drying chamber; said first lateral wall of the drying chamber being facing the second lateral wall of the drying chamber.

Conveniently, the drying plant according to the invention comprises at least one cassette comprising a plurality of seats negative reproducing the products to be made, said at least one cassette comprising at least one spacer element configured to create a passage for the airflow, for example in case of stacking a cassette with an additional cassette.

Advantageously, the drying plant according to the invention comprises at least one stack of cassettes comprising a plurality of cassettes superimposed and mutually spaced by the spacer elements so as to create at least one passage for the airflow between a cassette and that which is superimposed.

Further characteristics and advantages of the invention will be more evident from the detailed description of some preferred, but not exclusive, embodiments of a drying plant for the production of confectionery products according to the present invention.

### BRIEF DESCRIPTION OF THE DRAWINGS

Such description will be set forth hereunder with reference to the accompanying drawings provided by way of example only and thus not limiting, in which:

FIG. 1 shows a general block diagram of the process of the drying plant for the production of confectionery products;

FIG. 2 shows a schematic perspective view of a drying chamber surmounted by a delivery assembly, a suction assembly and an air treatment unit according to the present invention;

FIG. 2a shows a sectional schematic view of the drying chamber in FIG. 2 with the direction of the airflow depicted;

FIG. 3 shows a schematic perspective view of the suction assembly of FIG. 2;

FIG. 4 shows a schematic perspective view of the air treatment unit of FIG. 2;

FIG. 5 shows a schematic perspective view of the delivery assembly of FIG. 2;

FIG. 6 shows a magnified perspective view of at least one portion of the distribution channel according to the present invention; and

FIGS. 7a and 7b show a tray and a pallet, respectively.

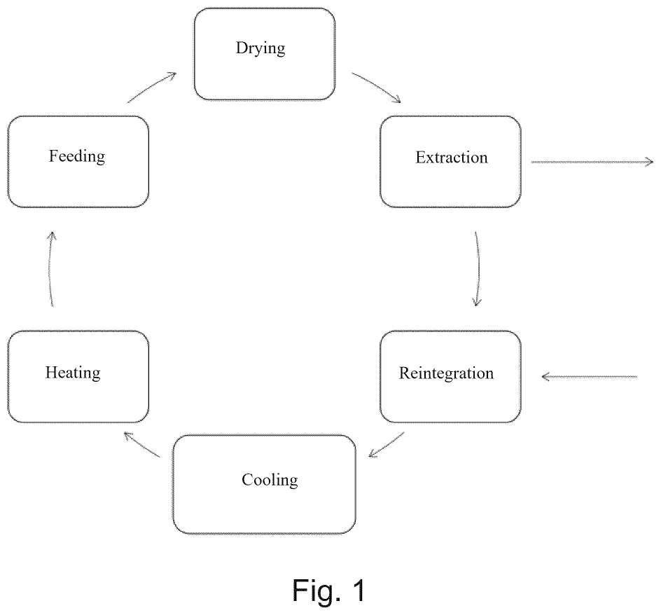

### DETAILED DESCRIPTION OF EMBODIMENTS OF THE INVENTION

With reference to the figures, a drying plant for the production of confectionery products, in particular gummy candies, according to the present invention is denoted by the numerical reference 100.

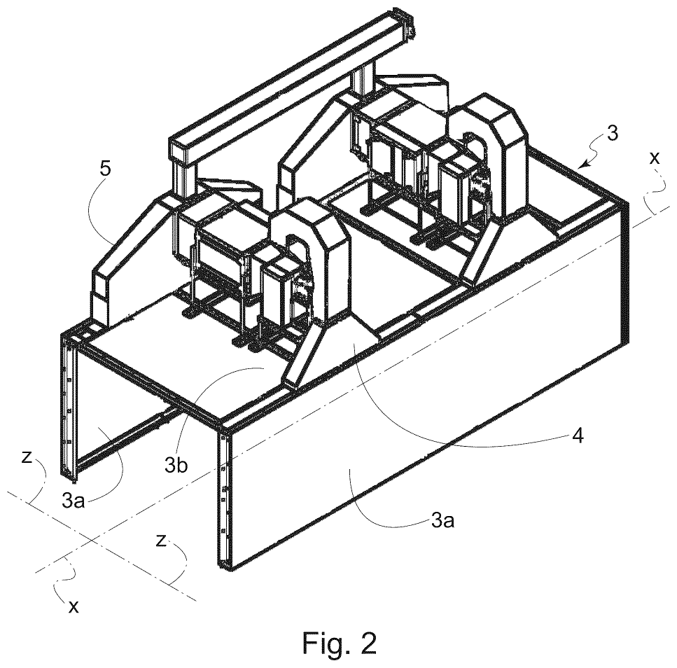

In FIGS. 2,2a a drying plant 100 is shown according to the present invention, comprising a drying chamber 3, an air treatment unit 2, a delivery assembly 4 and a suction assembly 5.

The drying chamber 3 comprises a box-shaped body comprising insulated lateral walls in fluid communication with the delivery assembly 4 configured to feed conditioned air into the chamber and a suction assembly 5 in fluid communication with the drying chamber 3 and specifically configured to draw air out of the drying chamber 3.

The drying chamber 3 extends along a longitudinal extent X-X axis and has a transverse Z-Z axis arranged substantially orthogonally to the longitudinal X-X axis.

The air treatment unit 2 is configured to subject the airflow to at least the following treatments of cooling and de-humidification, where the condensation is recovered and separated from the airflow, heating, to the temperatures specified by the recipe for the product being treated, and increasing pressure, which is achieved through a specific fan.

Possibly, the treatment unit 2 can be configured to implement other processes to the airflow, such as bleeding a portion of the outflow from the drying chamber in order to later make up at more favorable temperature and humidity conditions, i.e., once mixed with the main airflow they bring temperature and humidity to better values for the subsequent treatment.

For this purpose, the treatment unit 2 comprises at least one first exchanger to cool the air, at least one droplet separator, at least one second exchanger to heat the airflow and at least one fan to increase the airflow pressure.

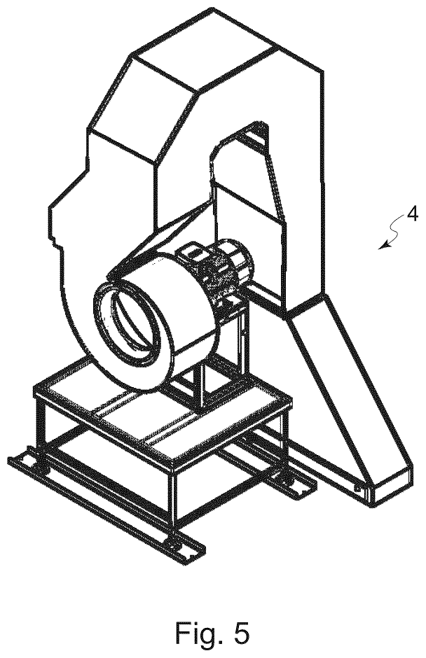

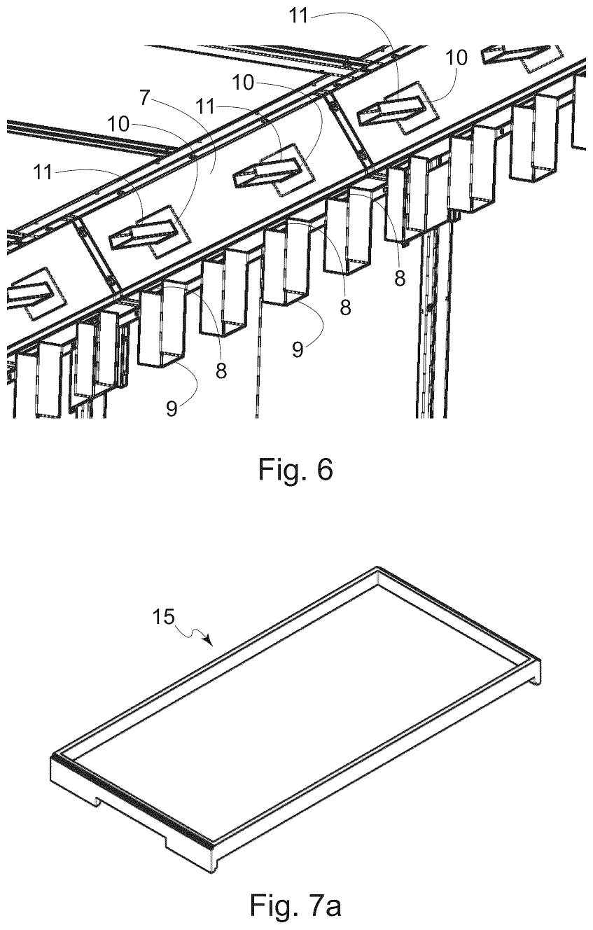

The delivery assembly, as best seen in FIG. 5, comprises an inner air distribution assembly 6 fluidically connected to the delivery assembly 4 and the suction assembly 5 to form a closed air circuit.

The inner air distribution assembly 6 comprises a portion outside the drying chamber 3 and a distribution channel 7 placed inside the drying chamber 3.

Preferably the distribution channel 7 extends in the upper portion of the drying chamber 3 for at least 70% of the longitudinal extent of said drying chamber 3. In the embodiment showed in the figures, the distribution channel 7 is constrained to the ceiling of the drying chamber 3, in particular, it is placed at the corner between the lateral wall 3a and the ceiling 3b of the drying chamber 3.

Preferably, the distribution channel 7 extends across the whole longitudinal extent of the drying chamber 3.

The distribution channel 7 has an inlet for the air coming from the delivery assembly.

The air inlet is generally placed in a central position, i.e., at about 50% of the overall extent of the distribution channel 7.

The distribution channel 7 has a closed section.

The distribution channel 7 has a trapezoidal section, with the minor base of the trapezoid facing downward, i.e., toward the inside of the drying chamber 3, so as to increase the pressure of the downward outflow of air.

Preferably, the shape of the section of the distribution channel 7 is that of a right trapezoid with the right side oriented vertically, that is, according to a 3a vertical lateral wall of the drying chamber 3.

In order to properly deliver an airflow inside the drying chamber 3, the distribution channel 7 has appropriate air outlets and systems adapted to direct the flow, which are described in more detail below. Here, the shapes, sizes and number of the outlet sections of the openings on the distribution channel 7 also allow maximum flow speed values in the chamber to be managed, where there is a need not to exceed certain speed thresholds inside the drying chamber itself.

Thus, the distribution channel 7 has a plurality of primary outlets 8 placed on the minor base of the trapezoid.

Therefore, the primary outlets 8 are also located in the upper portion of the drying chamber and in the proximity of a lateral wall 3a of the drying chamber 3.

There are no additional primary outlets located at different positions of the drying chamber 3.

The primary outlets 8 are responsible for sending a portion of the airflow directly to the lower portion of the drying chamber 3.

The primary outlets 8 have a rectangular plan section but could have a section of a different shape without departing from the scope of protection of the present invention.

Preferably, along the distribution channel 7, the primary outlets 8 all have the same shape.

Each primary outlet 8 has a plan area between 2000 mm² and 6000 mm². The primary outlets 8 are evenly spaced on the distribution channel 7.

Preferably, the primary outlets 8 are arranged at a mutual distance measured from their center of symmetry between 250 and 500 mm, including extremes.

In the embodiment shown in the figures, each primary outlet 8 comprises at least one first flow deflector fin 9 configured to direct the airflow toward the lower portion of the drying chamber 3.

Each first flow deflector fin 9 extends substantially vertically for at least 5 cm, more preferably for 10 cm, even more preferably for 20 cm.

In the embodiment shown in the figures, each first deflector fin 9 is arranged around the primary outlet so as to wrap around it at least partially.

Each first deflector fin 9 is arranged around the primary outlet 8 so as not to fully wrap it.

Each first deflector fin 9 has a thickness between 0.5 cm and 3 cm.

In the embodiment shown in the figures, each first deflector fin 9 is arranged in plan according to a C-shaped profile along the perimeter of the primary outlet 8.

Alternatively, each first deflector fin 9 could be arranged in plan according to a different profile but still along the perimeter of the primary outlet 8, without departing from the scope of protection of the present invention.

In order to convey a portion of the airflow to the upper area of the drying chamber 3, the distribution channel 7 has secondary outlets 10.

The secondary outlets 10 have a smaller plan area than the primary outlets 8. The distribution channel 7 has a plurality of secondary outlets 10 placed on the inclined side of the trapezoid.

Preferably, all the secondary outlets 10 have the same shape along the distribution channel 7.

Each secondary outlet 10 has a plan area between 1500 and 5000 mm²

The secondary outlets 10 are evenly spaced on the distribution channel 7. Preferably, the secondary outlets 10 are arranged at a mutual distance measured to their center of symmetry between 400 and 1000 mm, including extremes.

The secondary outlets 10 are mutually spaced at a greater distance than the mutual distance of the primary outlets 8, resulting in a more sparse distribution along the distribution channel 7, compared to the primary outlets 8.

In the embodiment shown in the figures, each secondary outlet 10 comprises at least one second flow deflector fin 11.

Each first flow deflector fin 9 extends substantially vertically for at least 5 cm, more preferably for 10 cm, even more preferably for 20 cm.

Each second flow deflector fin 11 extends substantially for at least 5 cm, more preferably for 10 cm, even more preferably for 20 cm.

Each second deflector fin is arranged along an axis adapted to form an acute angle a with the vertical between 50 and 90°, including extremes.

In the embodiment shown in the figures, each second deflector fin 11 is arranged around the secondary outlet so as to fully wrap it.

Each second deflector fin 11 has a thickness between 0.5 cm and 3 cm.

In the embodiment shown in the figures, each second deflector fin 11 is arranged in plan along the perimeter of the secondary outlet 10.

The introduction of the secondary outlets 10 in conjunction with the second deflector fins 11 on the distribution channel 7 allows a marked improvement in the homogeneity of the airflows in the drying chamber, a better control of the maximum speeds obtained by the airflow and a simultaneous increase in the overall flow rate within the cycle, with all the consequent related benefits.

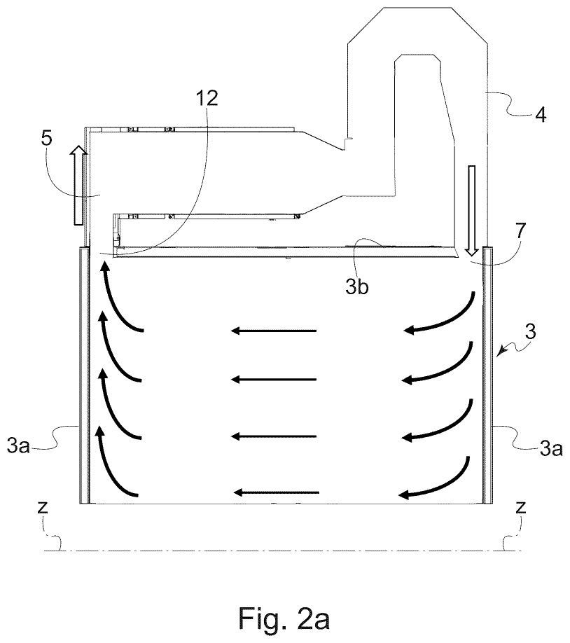

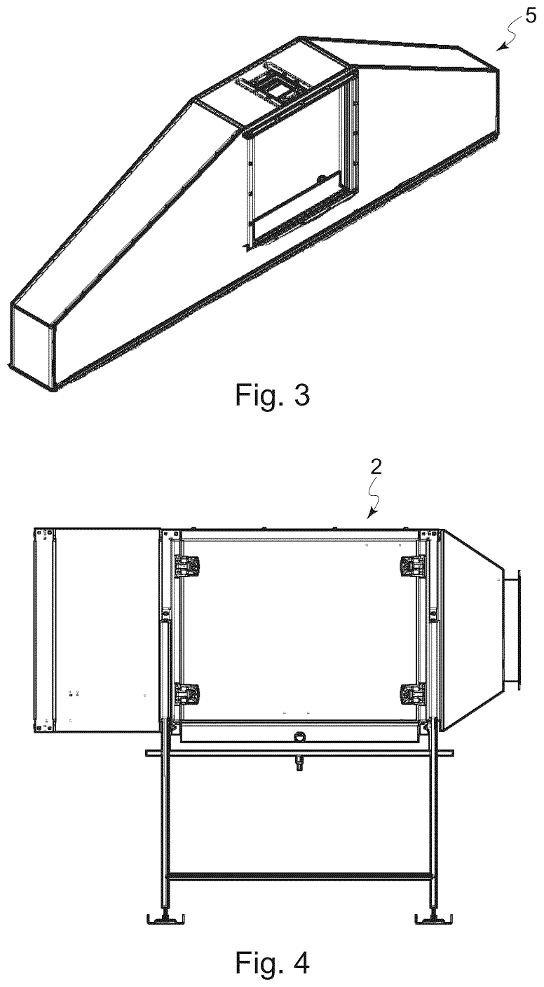

The suction assembly 5, according to the embodiment shown in FIG. 3, comprises air suction openings arranged in the upper portion of the drying chamber 3.

The air suction openings are away, in the transverse Z-Z axis direction, from the distribution channel 7 and in particular from its primary outlets 8, so that the inlet airflow to the drying chamber and coming from the distribution channel 7, once fed into the upper portion of the drying chamber 3 and sent in the lower portion of the drying chamber 3, crosses the drying chamber in transverse direction and exits the drying chamber through said suction assembly. In particular, the airflow comes out of the drying chamber 3 through the suction openings 12.

The airflow fed into the drying chamber, as better explained below, travels a path that is as least turbulent as possible and moves from a wall 3a of the drying chamber to the facing and opposite one, and then comes out of the drying chamber 3 through the suction openings 12.

In the drying chamber, the products to be dried are brought in and stored on special trays 15 appropriately superimposed to form stacks.

Each tray 15 comprises a plurality of seats negative reproducing the products to be made and at least one spacer element 19 configured to create a passage 20 for the airflow in case of stacking a cassette 15 with an additional cassette 15.

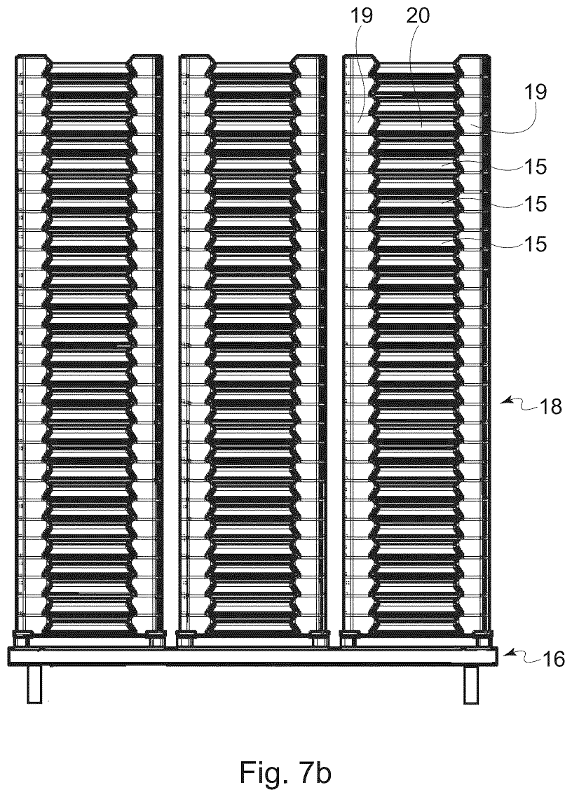

In FIG. 7b a stack of cassettes is shown, comprising a plurality of cassettes 15 superimposed and mutually spaced by said spacer elements 19, so as to create at least one passage 20 for the airflow between a cassette and the one which is superimposed.

Below we will describe a generic production cycle of gummy candies that begins with the introduction, inside the drying chamber 7, of the cassettes 15 containing the product to be dried, not shown in the figures, which come from the casting system,.

In the casting system, the casting step is implemented in which the cassettes 15, or trays, after being filled with the powder agent, in which the negative print of the products has been previously imprinted, moves on to the actual casting of the product, where the product mixture in liquid or viscous form is poured in precise doses inside each mold, which are imprinted in the powder agent. Once the cassette 15 has been filled with these two elements, it is generally sent to a stacking assembly.

In general, the stacking assembly, also not shown in the figures, is automated and is intended to stack the cassettes 15 on top of each other, generating stacks of a well-defined number of cassettes.

The cassettes 15 are superimposed to form a stack so that a passage 20 for the airflow is formed between one cassette and the one below that, thanks to the spacer elements 19.

The number of cassettes per stack 16 can vary depending on various parameters, such as the production volumes per cycle, height of the internal chamber and ventilation system, product type, etc.

The stacks 16 of trays are grouped in 2 or 3 stacks and are stored on bases, commonly referred to as pallets 18, which make the handling from these casting and stacking stations to the inside of the drying chamber 3 easy.

Once a pallet 18 is ready for handling, it is loaded by a means intended to move materials and inserted into the drying chamber 3.

Each pallet 18 stored inside each drying chamber 3 has a precise location that must be respected in order to have proper air circulation inside it. Incorrect positioning may cause imbalances in air circulation inside the drying chamber 3, once the cycle has started on both the incorrectly positioned pallet 18 and on the adjacent pallets. This results in worse distribution of the product quality and/or longer process times.

Linked to both of these consequences is an aggravation in economic terms.

Having placed all pallets 18 inside the drying chamber 3, the drying cycle can begin. The time duration of a cycle is depending on the type of product to be processed, to which a well-defined recipe corresponds, and on the energy efficiency of the process.

During the drying cycle, the air, which is the means used as the energy carrier, is processed in a continuous cycle first through an air treatment unit 2 and then sent and distributed inside the drying chamber 3. The air inside these treatment units 2 generally undergoes a very specific sequence of processes that may change during the cycle depending on the point of progress of the cycle itself and depending on what the specific working point specified in the treatment recipe for the product being dried in a given cycle must be. In general, the processes the air is subjected to are the following: cooling and de-humidification, where the condensation is recovered and separated from the airflow, heating to the temperatures specified by the recipe for the product being treated, and increasing pressure, which is achieved through a specific fan. To these processes also others may be added, such as bleeding a portion of the outflow from the chamber in order to later make up at more favorable temperature and humidity conditions, i.e., once mixed with the main flow they bring temperature and humidity to better values for the subsequent treatment.

The air, once it leaves treatment unit 2, will have the temperature, humidity and pressure values required for that point in the cycle. Temperature and humidity will be exchanged with the treated product in order to dry it, more specifically by giving up heat and removing moisture, whereas pressure energy will be expended through the path that the air will have to take from the delivery assembly 4, through the ducts and the whole drying chamber 3 until it returns to the same starting point, the cycle being closed or semi-closed.

The air must have, once it reaches the drying chamber 3, not only the correct temperature and humidity values which are specific to the current cycle and also to the state of progress of the cycle itself, but also sufficient kinetic and pressure energy to fit into the passage gaps between each cassette on each pallet 18 at each point of the drying chamber 3.

Thus, it becomes evident how important it is to have an optimal three-dimensional distribution of the flows inside the entire drying chamber 3. More specifically, a better distribution of the airflows directly results in at least two main effects: first, it is given by lower pressure drops that the airflow processed by the fans has to overcome in order to circulate, which thus results in lower energy consumption by the fans; second, it is given by a better distribution of the energy supply brought to the product during the drying cycle at each point of the drying chamber, i.e., from the point of view of the air treatment system, consumption would be lower and cycle times could be reduced, which would be further advantageous from the energy point of view.

In order to have a high three-dimensional distribution of flows inside the drying chamber 3, the airflow is fed into the upper portion of the drying chamber 3 through the primary outlets 8 and the secondary outlets 10.

Once fed into the drying chamber 3, the same is pushed downward, that is, towards the floor of the drying chamber 3.

Part of the airflow, flowing between a lateral wall 3a and the stacks, reaches the floor of the drying chamber 3, where once it meets the floor it turns to cross the drying chamber 3 according to the transverse axis and to reach the opposite lateral wall.

Once it reaches the opposite lateral wall 3a of the drying chamber 3, then the airflow rises to be captured by the suction openings 12 of the suction assembly and to come out of the drying chamber 3.

Part of the downward-pushed airflow sneaks between the passages 20 of the cassettes 15 of the stacks to cross the drying chamber 3 in a transverse direction, then rejoining with the remaining part of the airflow rising at the remaining lateral wall 3a.

The present invention allows to simultaneously increase and improve both the air flow rate fed into the drying chamber and its distribution inside the volume of the drying chamber and thus among the cassettes 15 contained therein during a generic cycle. In other words, it allows to increase the average speed of flows inside the drying chamber, to the benefit of the convective processes of heat and mass exchange, and at the same time to reduce the spread in product quality due to a better distribution of flows.

The present invention brings greater benefits the higher the limits related to the maximum speeds achievable inside the drying chamber. Typically, the starch-free applications are those that achieve the greatest performance gains and maximize energy efficiency of the system.

Several changes can be made to the embodiments described in detail, all anyhow remaining within the protection scope of the invention as defined by the following claims.

1. Drying plant (100) comprising a drying chamber (3), having a longitudinal extent along a longitudinal axis (X-X) and a transverse axis (Z-Z) arranged substantially orthogonally to said longitudinal axis, an air treatment unit (2), a delivery assembly (4) and a suction assembly (5), an inner air distribution assembly fluidically connected to said delivery assembly (4) and said suction assembly (5) so as to form a closed air circuit characterized in that said inner distribution assembly comprises at least one closed-section distribution channel (7) comprising a plurality of primary outlets (8) configured for feeding air into the upper portion of said drying chamber (3) and sending at least one portion of the inlet airflow into the lower portion of the drying chamber (3);
said distribution channel (7) extending in the upper portion of the drying chamber (3) for at least 70% of the longitudinal extent of said drying chamber (3);
said suction assembly (5) comprising air suction openings arranged in the upper portion of said drying chamber (3);
said air suction openings being away, in the transverse axis direction, from said distribution channel (7) so that the inlet airflow from said distribution channel (7), once fed into the upper portion of the drying chamber (3) and sent predominantly in the lower portion of the drying chamber (3), crosses said drying chamber (3) in transverse direction and exits said suction assembly (5).

2. Drying plant (100) according to claim 1, characterized in that each primary outlet (8) has a plan area between 2000 mm² and 6000 mm².

3. Drying plant (100) according to claim 1, characterized in that the primary outlets (8) are evenly spaced on the distribution channel (7).

4. Drying plant (100) according to claim 1, characterized in that each primary outlet (8) comprises at least one first deflector fin (9) extending substantially vertically from said distribution channel (7) and configured to direct the airflow towards the lower portion of said drying chamber (3); each first deflector fin (9) being arranged around a primary outlet (8) so as to wrap the primary outlet (8) at least partially.

5. Drying plant (100) according to claim 4, characterized in that each first deflector fin (9) is arranged is arranged around a primary outlet (8) so as not to fully wrap the primary outlet (8).

6. Drying plant (100) according to claim 1, characterized in that said distribution channel (7) comprises a plurality of secondary outlets (10) having a plan area which is less than that of said primary outlets (8); said secondary outlets (10) being evenly spaced along said distribution channel (7).

7. Drying plant (100) according to claim 6, characterized in that each secondary outlet (10) has a plan area between 1500 and 5000 mm².

8. Drying plant (10) according to claim 6, characterized in that each secondary outlet (10) comprises at least one second flow deflector fin (11).

9. Drying plant (100) according to claim 8, characterized in that each second deflector fin (11) is arranged according to an axis adapted to form an acute angle a with the vertical between 50 and 90°, including extremes.

10. Drying plant (100) according to claim 8, characterized in that each second deflector fin (11) is arranged around a secondary outlet (10) so as to fully wrap the secondary outlet (10).

11. Drying plant (10) according to claim 1, characterized in that said distribution channel (7), in section, has a trapezoidal shape converging downwardly.

12. Drying plant (10) according to claim 1, characterized in that said distribution channel (7) is placed at a first lateral wall (3a) of said drying chamber (3); said suction assembly (5) being arranged at a second lateral wall (3a) of said drying chamber; said first lateral wall (3a) of said drying chamber (3) being facing said second lateral wall (3a) of said drying chamber (3).

13. Drying plant (10) according to claim 1, characterized in that it comprises at least one cassette (15) comprising a plurality of seats negative reproducing the products to be made, said at least one cassette (15) comprising at least one spacer element configured to create a passage for the airflow in case of stacking a cassette (15) with an additional cassette (15).

14. Drying plant (10) according to claim 13, characterized in that it comprises at least one stack of cassettes comprising a plurality of cassettes (15) superimposed and mutually spaced by said at least one spacer element so as to create at least one passage for the airflow between a cassette (15) and the one which is superimposed.

15. Drying plant (100) according to claim 4, characterized in that said distribution channel (7) comprises a plurality of secondary outlets (10) having a plan area which is less than that of said primary outlets (8); said secondary outlets (10) being evenly spaced along said distribution channel (7).

16. Drying plant (100) according to claim 2, characterized in that said distribution channel (7) comprises a plurality of secondary outlets (10) having a plan area which is less than that of said primary outlets (8); said secondary outlets (10) being evenly spaced along said distribution channel (7); and each secondary outlet (10) has a plan area between 1500 and 5000 mm².

17. Drying plant (10) according to claim 16, characterized in that each secondary outlet (10) comprises at least one second flow deflector fin (11).
